(19) United States
(12) Patent Application Publication
(10) Pub. No.: US 2007/0038315 A1
(43) Pub. Date: Feb. 15, 2007

(54) Remote Controller And Related Method For Controlling Multiple Devices

(76) Inventor: Chia-Hsing Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/382,062

(22) Filed: May 8, 2006

(30) Foreign Application Priority Data
Aug. 10, 2005 (TW) 094127196

(51) Int. Cl. G05B 19/18

(52) U.S. Cl. 700/65; 700/66

(57) ABSTRACT

A remote controller controls various electronic devices through device instructions corresponding to the electronic devices. The device instructions are grouped into group instructions for various requirements. Therefore, any one of the group instructions includes device instructions of the same electronic device or different electronic devices. Each group instruction corresponds to a user-defined manipulation, such as a given handwriting trace or voice. In this way, a user can use a single handwriting trace or voice command to order the remote controller to send a corresponding group instruction. Thus, different electronic devices can be controlled to serially execute various instructions.

### BACKGROUND OF THE INVENTION

1. Field of the Invention

The invention relates to a remote controller and related method for controlling multiple devices, and more specifically, to a remote controller and related method for controlling multiple electronic devices by means of a single manipulation to execute a plurality of functions and operations sequentially.

2. Description of the Prior Art

In modern information society, various electronic devices are utilized and become part of modern life. For example, video players for storing and playing multimedia, recorders, audio systems, televisions, and air conditioners are popular electronic devices. For the convenience of operating popular electronic devices, remote controllers are utilized for controlling the electronic devices with wireless remote controlling techniques. Generally speaking, a remote controller of an electronic device has many buttons, each of which represents a function of the electronic device. When a user pushes a specific button, the remote controller transmits a wireless remote control instruction to the corresponding electronic device so that the electronic device executes a specific function corresponding to the pushed button.

However, with the increasing functions of the electronic devices, operation of the electronic devices become more complicated. A user has to push a plurality of buttons for making the corresponding electronic device execute a single specific function. For example, a modern television accesses multiple multimedia programs on wireless/cable channels. However, when a user wants to watch a program of a given channel, except for turning on the television with a remote controller, complex operations of choosing channels are also required. For example, on a remote controller, a series of buttons representing various numbers are pushed by the user to choose a specific channel. The operation of pushing the buttons for choosing the specific channel is very inconvenient of the users.

In addition, in prior art remote control techniques, since every electronic device is operated by a corresponding remote controller, when a user would like to coordinate the operations of several electronic devices, the user has to switch from remote controller to remote controller repeatedly. For example, when a user wants to play the multimedia within a disc with a compact disk player, the user has to turn on the television with a remote controller corresponding to the television, then the user has to turn on the compact disc player with the remote controller corresponding to the compact disc player, and the compact disc player starts playing. For example, when a user watches the program of a given channel and wants to record the program with a recorder, the user has to turn on the television with a corresponding remote controller and turn the television to the given channel. Then the user has to turn on the recorder with the remote controller corresponding to the recorder, switch the recorder to the given channel, and start recording. Switching between different remote controllers is very inconvenient for a user. Maintaining several remote controllers is also a heavy burden to the user. For example, the user has to replace the batteries of each remote controller.

### SUMMARY OF THE INVENTION

It is therefore a primary objective of the claimed invention to provide a remote controller for controlling multiple devices by single operation to integrate control of different electronic devices for convenience.

The claimed invention provides a remote controller for controlling multiple devices. The remote controller comprises a memory module for storing at least a group instruction and at least a corresponding reference signal, each group instruction having at least a device instruction, and each device instruction capable of driving an electronic device to execute a function; a decision module for determining whether an operation signal matches the reference signal in the memory module; and a transmitting module. When the operation signal matches the reference signal, the transmitting module transmits a corresponding group instruction of the reference signal to make a plurality of device instructions drive the corresponding electronic device to execute sequentially a corresponding plurality of functions.

The claimed invention also provides a method for a remote controller to control multiple devices. The method comprises determining whether a control signal matches a recorded reference sample, wherein the reference sample corresponds to a group instruction. When the control signal matches the recorded reference sample, the corresponding group instruction is transmitted, wherein the group instruction has at least a device instruction, and wherein each device instruction is capable of driving an electronic device to execute a function. The device instructions of the group instruction are capable of driving corresponding electronic devices to execute related functions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a remote controller of the present invention.

FIG. 2 is a diagram of the remote controller of the present invention under a scan mode or a setting mode.

FIG. 3 is a diagram of the remote controller of the present invention under a remote-controlling mode.

FIG. 4 is a flowchart of the remote controller of the present invention operated between the scan mode, the setting mode, and the remote-controlling mode.

FIG. 5 is a diagram of a preferred embodiment of a graphic interface of the remote controller of the present invention operated under the scan mode.

FIG. 6 and FIG. 7 are both diagrams of a preferred embodiment of the graphic interface of the remote controller of FIG. 1 operated under the setting mode.

FIG. 8 and FIG. 9 are both diagrams of a preferred embodiment of the graphic interface of the remote controller of FIG. 1 operated under the remote-controlling mode.

FIG. 10 is a block diagram of another remote controller of the present invention.

### DETAILED DESCRIPTION

A remote controller of the present invention records remote control instructions of remote controllers corresponding to various electronic devices. A user remotely controls various electronic devices with the remote controller of the present invention by transmitting remote control instructions, which are also denoted as device instructions, so that the user is able to remotely control various electronic devices with a single remote controller. Moreover, the remote controller of the present invention groups device instructions of various electronic devices into a single group instruction. Therefore, a group instruction comprises a plurality of device instructions of various electronic devices and corresponds to a single operation. This means that a user is able to trigger a group instruction with a single manipulation (i.e. a single button push). The remote controller of the present invention transmits the plurality of device instructions belonging to various electronic devices sequentially according to the contents of the group instruction. Therefore, the electronic devices complete the sequential operations and are coordinated for the convenience of the user. A group instruction defined by a user can comprise instructions for turning on a television, switching the television to a specific channel, turning on a recorder, turning the recorder to the specific channel, and ordering the recorder to record the specific channel. A user triggers the group instruction with the remote controller of the present invention by performing a corresponding manipulation, then the remote controller of the present invention transmits a sequence of corresponding device instructions of the group instruction to the television and the recorder.

Regarding the manipulation performed by the user, except for pushing buttons, handwriting traces or voice commands can also be accepted by the remote controller of the present invention. For example, a touch module can be disposed in the remote controller of the present invention to detect handwriting traces. When a user triggers a specific device instruction or a specific group instruction with the remote controller of the present invention, the user writes a corresponding handwriting trace on the touch module of the remote controller of the present invention so that the remote controller transmits the corresponding device instruction or the corresponding group instruction, and the user is thus able to trigger the instructions explicitly.

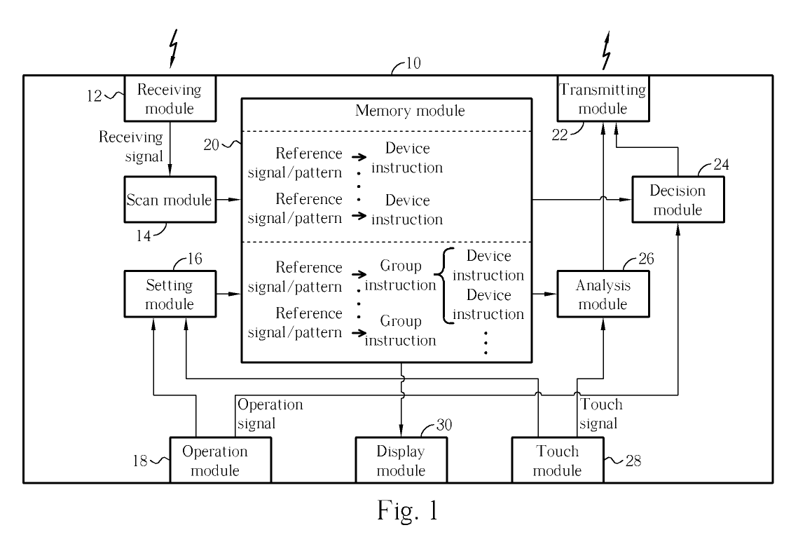

Please refer to FIG. 1, which is a block diagram of a remote controller 10 of the present invention. The remote controller 10 comprises a transmitting module 22, a decision module 24, an analysis module 26, a memory module 20, an operation module 18, a touch module 28, a display module 30, a setting module 16, a receiving module 12, and a scan module 14. For reaching the aim of controlling multiple electronic devices with a single remote controller in the present invention, the memory module 20 can be implemented by a non-volatile storage device (for example, a flash memory). The memory module 20 is utilized for storing device instructions corresponding to various electronic devices and group instructions generated from various groups of device instructions. The transmitting module 22 transmits the device instructions and the group instructions through wireless remote control signals, for example, infrared remote control signals. Therefore, the remote controller 10 of the present invention can control various electronic devices with the device instructions and the group instructions. In the remote controller 10 of the present invention, the receiving module 12 receives the wireless remote control instructions transmitted by the remote controllers corresponding to various electronic devices. The receiving module 12 can be an infrared remote control signal receiver. The scan module 14 analyzes the signal characteristics of the wireless remote control instructions. The signal characteristics can be the patterns of signal encoding modulation, the encoded contents of instructions, and the waves of signals. The scan module 14 also records the remote control instructions of each electronic device as the corresponding device instructions and stores the corresponding device instructions in the memory module 20.

For reaching the aim of remote controlling electronic devices with the remote controller 10 by the manipulations of users, standard manipulations are stored in the memory module 20 in the form of reference signals or reference patterns. Therefore, each device instruction or each group instruction corresponds to a reference signal or a reference pattern. The operation module 18 and the touch module 28 are utilized for receiving the manipulations of the users. The operation module 18 is utilized to receive a manipulation of pushing a button and to provide an operation signal corresponding to the manipulation. The touch module 28 is utilized to detect a handwriting trace and provide a touch signal corresponding to the handwriting trace. The decision module 24 is utilized to determine which reference signal the operation signal matches. The transmitting module 22 then transmits a device instruction (or a group instruction) corresponding to the reference signal. The analysis module 26 is utilized to analyze the characteristic of the handwriting trace according to the touch signal so as to compare the handwriting trace with the reference patterns recorded in the memory module 20. The characteristic of the handwriting trace can be a contour or a turning. If the handwriting trace matches some reference pattern recorded in the memory module 20, the transmitting module 22 transmits a device instruction (or a group instruction) corresponding to the reference pattern. Moreover, the display module 30 displays the operations of the remote controller 10 with graphs.

While being implemented, the operation module 18 comprises a plurality of physical buttons, which can be operated mechanically and can be pushed-down. The touch module 28 can be a touch pad and is utilized to detect a handwriting trace. In a preferred embodiment of the present invention, the display module 30, the operation module 18, and the touch module 28 can be integrated on a touch display panel. A plurality of virtual buttons are displayed on the touch display panel and are utilized as the buttons of the operation module 18. The virtual buttons are implemented by a plurality of sensing blocks disposed on the touch display panel, and each sensing block corresponds to a virtual button. When a user touches some sensing block, this means that the user pushes the corresponding virtual button simultaneously. A handwriting block can also be implemented on the touch display panel to implement the touch module 28.

Moreover, a user can also define the manipulations corresponding to each device instruction or each group instruction in the remote controller 10 of the present invention. When a user defines the manipulations, the manipulations defined by the user are transmitted to the setting module 16 through the operation module 18 and the touch module 28. The setting module 16 then stores the operation signals and touch signals corresponding to the manipulations in the form of reference signals and reference patterns. The reference signals and reference patterns also correspond to the device instructions and the group instructions. Therefore, the user can control the remote controller 10 to activate the device instructions and group instructions with the manipulations defined by the user.

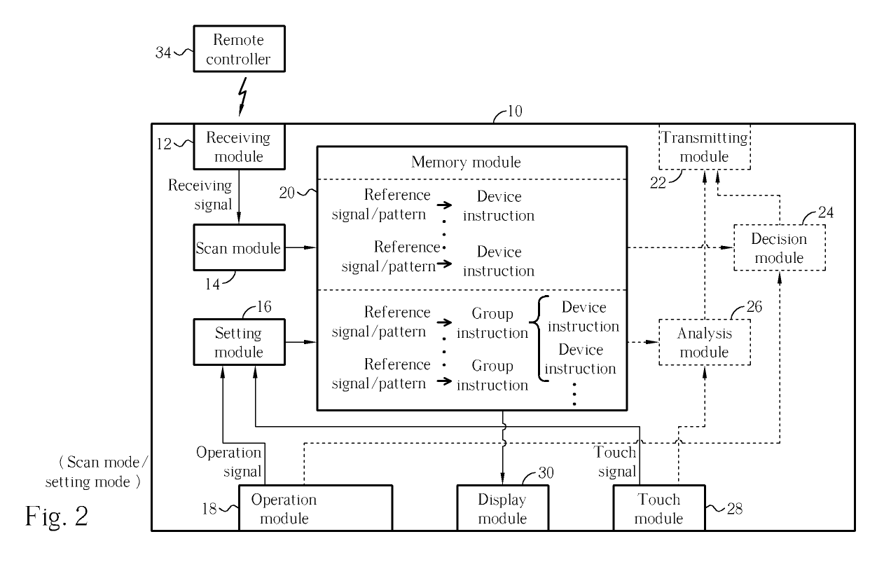

Before controlling various electronic devices with the remote controller 10 of the present invention, the remote controller 10 can be operated under a scan mode so that the remote controller 10 scans the remote controllers corresponding to the electronic devices and connects with the electronic devices. Therefore, the remote controller 10 is informed of the remote control instructions (or the device instructions) accepted by the electronic devices. Moreover, the remote controller 10 can also be operated under a setting mode. Therefore, a user can group the device instructions corresponding to an electronic device into a group instruction and can define the manipulations corresponding to each device instruction/group instruction. After completing the aforementioned scan mode and the aforementioned setting mode, the remote controller 10 of the present invention can be operated under a remote-controlling mode so that the user controls various electronic devices by the manipulations defined by the user with the remote controller 10 of the present invention. FIG. 2 is a diagram of the remote controller 10 of the present invention under a scan mode or a setting mode.

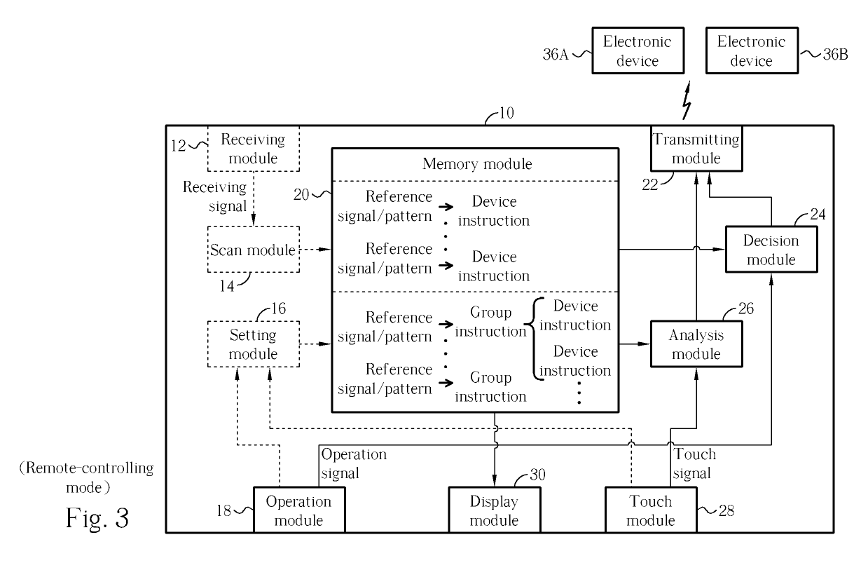

FIG. 3 is a diagram of the remote controller 10 of the present invention under the remote-controlling mode. As shown in FIG. 2, when the remote controller 10 is operated under the scan mode, the receiving module 12 begins working. Therefore, the user connects a remote controller 34 corresponding to a specific electronic device with the receiving module 12 so that the receiving module 12 receives remote control instructions transmitted by the remote controller 34 and records the remote control instructions as device instructions in the memory module 20. Under the setting mode, the manipulations corresponding to the operation signals or the touch signals on the operation module 18 and the touch module 28 are transmitted to the setting module 16. Therefore the setting module 16 connects the device instructions defined by a user with the manipulations defined by the user according to decisions of the user. Moreover, the user also groups the device instructions corresponding to the electronic devices as a group instruction and connects the group instruction with the manipulations defined by the user.

After finishing the scan mode and the setting mode in FIG. 2, the remote controller 10 can be operated under the remote-controlling mode of FIG. 3. Under the remote-controlling mode, a user is able to control a plurality of electronic devices with the remote controller 10 of the present invention. The electronic devices 36A and 36B of FIG. 3 are taken as examples. As shown in FIG. 3, the manipulations on the operation module 18 are transformed into related operation signals and transmitted to the decision module 24. The decision module 24 thus compares the operation signals with the reference signals recorded in the memory module 20 according to the connections also recorded in the memory module 20. The decision module 24 also orders the transmitting module 22 to transmit the device/group instructions corresponding to a reference signal matched with an operation signal compared by the decision module 24. Similarly, a handwriting trace on the touch module 28 is transformed into a corresponding touch signal, which is then transmitted to the analysis module 26. The touch signal is compared with the stored reference patterns by the analysis module 26 to determine whether the handwriting trace corresponding to the compared touch signal matches with any stored reference pattern. If the analysis module finds that a reference pattern matches the touch signal, the transmitting module 22 transmits the device/group instructions corresponding to the reference pattern. Therefore, the electronic devices are integrally remote-controlled by the user.

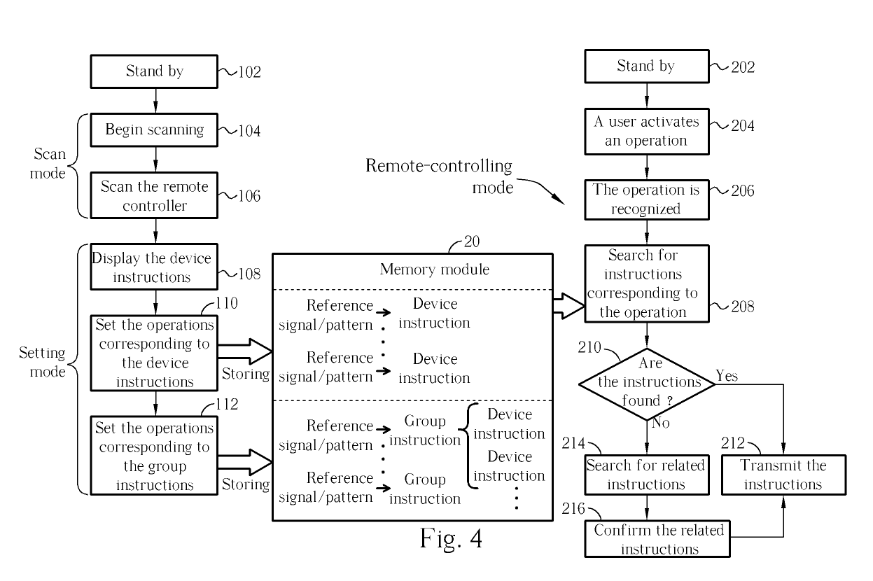

Please refer to FIG. 4, and refer to FIG. 1, FIG. 2, and FIG. 3, as well. FIG. 4 is a flowchart of the remote controller 10 of the present invention operated between the scan mode, the setting mode, and the remote-controlling mode. The steps of FIG. 4 comprise:

Step 102: The remote controller 10 stands by.

Step 104: The remote controller 10 is operated under the scan mode.

Step 106: The remote controller 10 of the present invention receives the remote control instructions transmitted from the other remote controllers corresponding to the other electronic devices to be informed of the remote control instructions capable of being received by the electronic devices. A scan procedure comprises Step 104 and Step 106.

Step 108: The remote controller 10 is operated under the setting mode and displays the scanned device instructions. For example, the scanned instructions can be displayed with the display module 30.

Step 110: The connection between a device instruction and a corresponding manipulation is defined by a user. The connection is stored in the memory module 20.

Step 112: Related device instructions of several different electronic devices can also be grouped as a group instruction. And a corresponding manipulation is also defined for the group instruction. The connection between the group instruction and the corresponding manipulation is also stored in the memory module 20. A setting procedure comprises Step 108 to Step 112.

Step 202: After the remote controller 10 completes the scan procedure and the setting procedure, the remote controller 10 stands by.

Step 204: Under the remote-controlling mode, a user performs a manipulation with the operation module 18 or the touch module 28 of FIG. 3. An operation signal or a touch signal is generated from the manipulation.

Steps 206 and 208: The remote controller 10 detects the manipulation performed by the user and compares the operation signal or the touch signal corresponding to the manipulation with the reference signals or the reference patterns stored in the memory module 20.

Step 210: If the operation signal or the touch signal corresponding to the manipulation matches a specific reference signal or reference pattern, proceed to Step 212. Otherwise, proceed to Step 214.

Step 212: Transmit the device instruction or group instruction corresponding to the specific reference signal/reference pattern with the transmitting module 22. Therefore, the aim of remote controlling is reached.

Step 214: The manipulation of the user cannot be recognized with the remote controller 10. For example, if the characteristic of a handwriting trace on the touch module 28 differs from the manipulations corresponding to the stored reference patterns, the remote controller 10 of the present invention can help the user to search for the related device or group instructions. For example, in Step 206 and 208, when the analysis module 26 compares a handwriting trace with each reference pattern, specific algorithms can be utilized to quantify and calculate the difference between the handwriting trace and each reference pattern. If the difference between the handwriting trace and a specific reference pattern is less than a specific limit, the procedure can thus proceed to Step 212. Otherwise, the procedure proceeds to Step 214. However, in Step 214, the analysis module 26 can still take reference patterns with smaller difference as candidate reference patterns and can display the device or group instructions corresponding to the candidate reference patterns. For example, the corresponding device or group instructions can be displayed with the display module 30. Since the candidate reference patterns are similar to the specific handwriting trace, it is possible that the user would like to trigger one of the device or group instructions corresponding to the candidate reference patterns. Therefore, the remote controller 10 of the present invention displays the possible device or group instructions to help the user for further recognition.

Step 216: A device or group instruction of the possible device or group instructions is chosen by the user, and the procedure proceeds to Step 212.

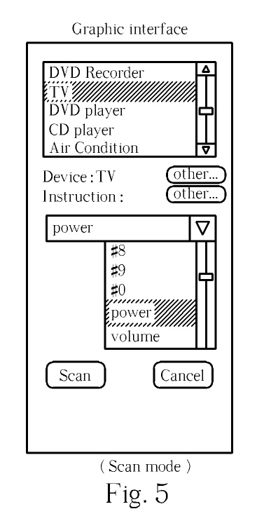

As mentioned before, in a preferred embodiment of the present invention, the remote controller 10 of the present invention is capable of integrally implementing the functions of the display module 30, the operation module 18, and the touch module 28 so that a user can remotely control a plurality of electronic devices in an intuitive manner. A preferred embodiment of the present invention is shown in FIG. 5 to FIG. 9. The preferred embodiment shows that the remote controller 10 of the present invention helps a user to operate the steps of FIG. 4 with a graphic interface on a touch display panel.

FIG. 5 is a diagram of a preferred embodiment of a graphic interface on the remote controller 10 of the present invention operated under the scan mode. As shown in FIG. 5, when the remote controller 10 of the present invention operates under the scan mode (or the scan procedure), the graphic interface shown in FIG. 5 helps a user to scan available device/group instructions. For example, when a user would like to control a television with the remote controller 10 of the present invention, the remote controller 10 has to scan remote-control instructions transmitted by the remote controller corresponding to the television in the first place. The user pushes a button corresponding to a specific instruction transmitted from the remote controller corresponding to the television. The specific instruction is then received by the receiving module 12 of the remote controller 10 shown in FIG. 2. An identifier is also defined for the specific instruction in the remote controller 10 for a latter setting procedure and for conveniently using the instruction. In the graphic interface of FIG. 5, popular electronic devices are displayed, and identifiers of the instructions corresponding to the popular electronic devices are also displayed. The popular electronic devices comprise a DVD (digital video disc) recorder, a DVD player, a CD (compact disc) player, an air conditioner (as “Air Condition” in FIG. 5). In FIG. 5, taking a television as an example, power represents the power of the television, volume represents the volume of the television, and the numbers 0-9 represent the numbers of the channels. The remote controller 10 of the present invention also accepts the device or group instructions inputted in other manners. For example, in FIG. 5, when the virtual button “other . . . ” is pushed, a virtual keyboard (or a handwriting block) is implemented by the graphic interface so that the user can input an identifier of a device or group instruction directly.

When the remote controller 10 scans the power button of the remote controller corresponding to a television, the transmitting window of the remote controller corresponding to the television aims the receiving module 12 of the remote controller 10 of the present invention. The TV button and the power button are sequentially pushed as the identifiers of the instructions, and then the virtual button “Scan” is also pushed on the graphic interface so that the receiving module 12 prepares to receive a remote control instruction transmitted from the remote controller corresponding to the television. Therefore, the user pushes the button on the remote controller corresponding to the television so that the receiving module 12 starts receiving the remote control instruction and recording the remote control instruction. Similarly, when the remote controller 10 scans the volume button of the remote controller corresponding to the television, the TV button and the volume button are pushed sequentially. Then the virtual button Scan and the volume button on the remote controller corresponding to the television are sequentially pushed so that the remote control instruction is received by the receiving module 12 of the remote controller 10 of the present invention. The received remote control instruction is thus recorded in the memory module 20 of FIG. 2. By similar steps, the remote controller 10 is able to scan various remote control instructions of various electronic devices sequentially. A database storing the recorded remote control instructions is thus established in the memory module 20 of the remote controller 10 of the present invention.

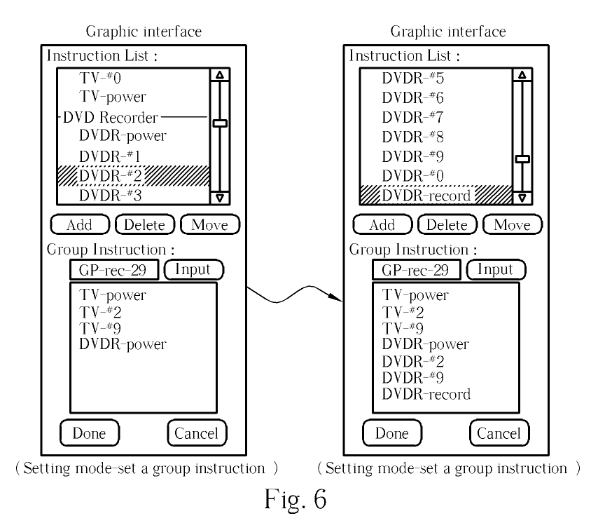

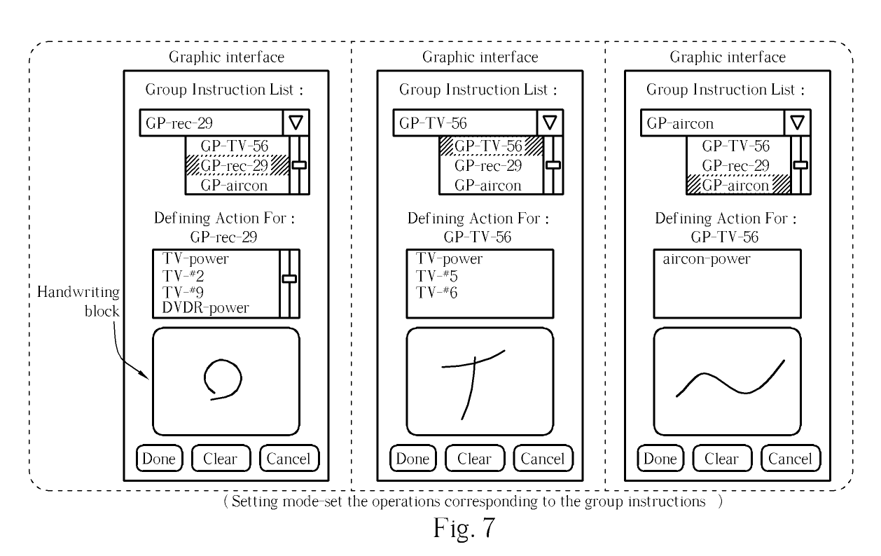

FIG. 6 and FIG. 7 are both diagrams of a preferred embodiment of the graphic interface on the remote controller of FIG. 1 operated under the setting mode. FIG. 6 and FIG. 7 also show how the remote controller 10 helps a user to perform the Step 112 of FIG. 4 with the graphic interface. In Step 112, a user groups various device instructions of related electronic devices into a group instruction and connects a corresponding manipulation with the group instruction. In FIG. 6, the graphic interface shown in FIG. 6 is utilized by the remote controller 10 to help the user edit the group instruction. First, the graphic interface in FIG. 6 displays all scanned device instructions. For example, corresponding to the remote controller of the television, TV-#0 represents the button “0”, and TV-power represents the button “power”. DVDR (digital video disc recorder)-power represents the button of “DVDR”. The user can designate a group instruction first. For example, the user pushes the virtual button “Input” on the graphic interface to enter the identifier of the group instruction GP-rec-29. Then a device instruction is chosen from a list of device instructions displayed on the graphic interface. By pushing the virtual button “Add”, the chosen device instruction is thus added into the definition of the group instruction. In FIG. 6, before the group instruction GP-rec-29 is added in the definition, the group instruction comprises the device instructions TV-power, TV-#2, TV-#9, DVDR-power, DVDR-#2, DVDR-#9, and DVDR-record. The device instructions TV-#2 and TV-#9 make the television turn to channel 29; the device instruction DVDR-power makes the DVDR turned on; the device instructions DVDR-#2, DVDR-#9, and DVDR-record make the DVDR start recording the program shown on channel 29. In other words, after completing setting of the group instruction GP-rec-29, as long as the user triggers the group instruction GP-rec-29 with the remote controller 10, the remote controller 10 begins transmitting the device instructions defined in the group instruction GP-rec-29 sequentially to the television and the DVDR. Therefore, the television displays the programs on channel 29 while the DVDR records the programs played on channel 29. With a group instruction, a user easily remotely controls various related functions of various electronic devices sequentially. Moreover, other supporting functions are provided to help a user edit the definition of a group instruction in the remote controller 10. In the graphic interface of FIG. 6, a user can choose a specific device instruction defined in a group instruction and delete the chosen device instruction by pushing the virtual button “Delete”. The user can also change the order of the device instructions defined in the group instruction by pushing the virtual button “Move”. The user finishes editing the definition of the group instruction by pushing the virtual button “Done”.

The graphic interface shown in FIG. 7 can be utilized to help a user set manipulations corresponding to various group instructions. As shown in FIG. 7, the graphic interface displays the defined group instructions and the device instructions corresponding to the defined group instructions. The graphic interface also has a handwriting block to implement the touch module 28 of FIG. 2 under the setting mode. Therefore, the user can choose a group instruction and define a handwriting trace corresponding to the group instruction. As shown in FIG. 7, a user defines the group instruction GP-rec-29 defined in FIG. 6 with a handwriting trace “o”. In other words, under the setting mode shown in FIG. 7, after the handwriting trace “o” is detected by the touch module 28 in FIG. 2, the handwriting trace “o” is recorded in the memory module 20 as a reference pattern corresponding to the group instruction GP-rec-29. Similarly, a handwriting trace “T” is recorded as a reference pattern corresponding to the group instruction GP-TV-56. The definition of the group instruction GP-TV-56 comprises turning on the power of a television and setting the channel of the television as 56 with the buttons “5” and “6”. This means that a group instruction of the present invention can also comprise a series of device instructions corresponding to a single electronic device, such as a television. Moreover, as shown in FIG. 7, the user can also define the handwriting trace “≠” as the reference pattern corresponding to the group instruction GP-aircon with the graphic interface under the setting mode. The group instruction GP-aircon can only comprise a device instruction aircon-power, which is utilized to turn on an air conditioner. With the graphic interface of FIG. 7 under the setting mode, various virtual buttons are provided to help a user define the manipulations corresponding to various group instructions in the present invention. For example, the virtual button “Clear” is utilized to clear a handwriting trace on the handwriting block of the graphic interface so that another handwriting trace can be inputted on the handwriting block.

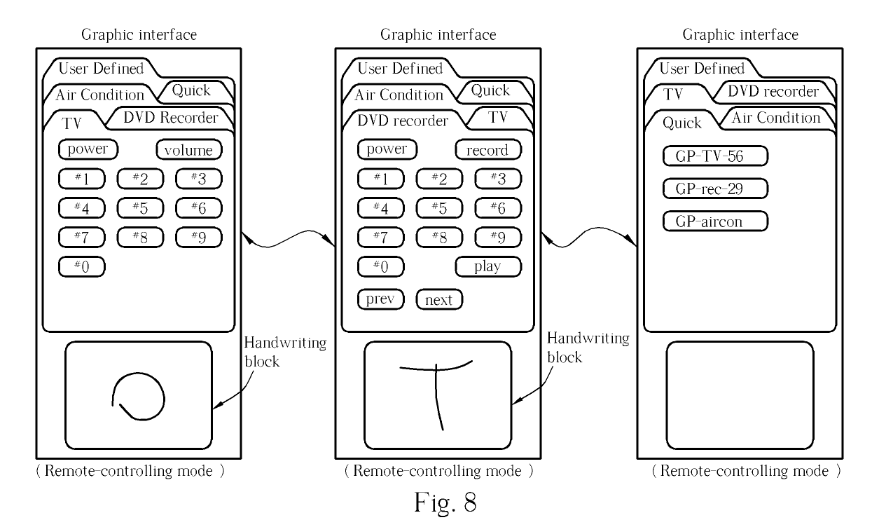

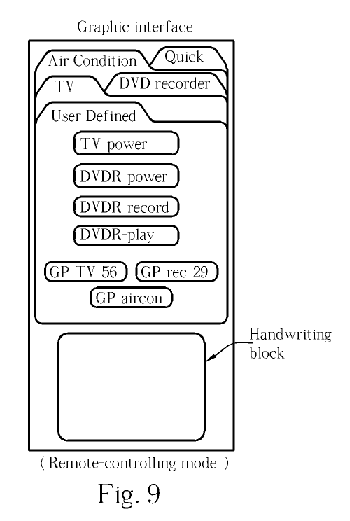

FIG. 8 and FIG. 9 are both diagrams of a preferred embodiment of the graphic interface on the remote controller of FIG. 1 operated under the remote-controlling mode. One of the primary aims of the present invention is remote controlling a plurality of electronic devices with a single remote controller conveniently. Therefore, a flexible graphic interface under the remote-controlling mode is provided for switching various electronic devices in the present invention. The graphic interface under the remote-controlling mode comprises a plurality of tags, each tag corresponding to a unique electronic device. For example, if the remote controller 10 has scanned the device instructions of a television, an air conditioner, and a DVD recorder under the scan mode and the setting mode, a tag is established on the graphic interface for each electronic device under the remote-controlling mode. After the user touches the tag corresponding to the television, each virtual button is utilized to correspond to each device instruction corresponding to the television on the graphic interface. For example, the virtual button power on the television tag is the power button corresponding to the television, and so on. Similarly, when a user would like to remotely control a DVD recorder, he or she touches the tag corresponding to the DVD recorder. Therefore, the remote controller 10 of the present invention displays the device instructions of the DVD recorder to the user in the form of virtual buttons so that the user can remotely control the DVD recorder by pushing the virtual buttons. Moreover, a tag is set for each group instruction in the remote controller 10 of the present invention, for example, refer to the tag “Quick” in FIG. 8. Therefore, each group instruction is available for users in the form of virtual buttons in the present invention. For example, when a user pushes the virtual button GP-rec-29, the remote controller 10 transmits the group instruction GP-rec-29 defined in FIG. 6 so that the remote controller 10 transmits a series of device instructions to the television and the DVD recorder.

The remote controller 10 of the present invention also provides a user with the ability to define virtual buttons of each tag. Under the setting mode, a user can establish a tag and assign the virtual buttons in the tag. Under the remote-controlling mode, the user establishes a preferred interface with the tags established by the user. In FIG. 9, a user touches the “User Defined” tag, and the tag comprises device instructions of various electronic devices according to the assignment of the user. Therefore, the user operates different device or group instructions by pushing different virtual buttons of a single tag. In FIG. 8 and FIG. 9, a handwriting block is also provided so that a user can control the remote controller 10 with handwriting traces anytime. In FIG. 8, a user writes a handwriting trace “o” or “T” in the handwriting block so that the remote controller 10 of the present invention transmits the group instruction GP-rec-29 or GP-TV-56 according to the definition in FIG. 7.

In other words, in the remote controller 10 of the present invention, a user explicitly operates the device or group instructions by pushing virtual buttons or writing handwriting traces according to his or her requirements. In the embodiments of FIG. 8 and FIG. 9 and under the setting mode, a graphic interface can also be provided to a user so that the user can edit the sizes, the forms, and the locations of the virtual buttons of each tag in the graphic interface. As mentioned before, the virtual buttons are the sensing blocks on the touch display panel, and each sensing block represents a virtual button. A signal generated by touching a sensing block represents a reference signal in FIG. 2. When the remote controller 10 operates under the remote-controlling mode of FIG. 3 and when the user touches a specific sensing block, the decision module 24 detects which virtual button is pushed according to the reference signals generated before. The embodiments of the present invention are not limited by the embodiments of FIG. 5 to FIG. 9 implemented with touch display panels. For example, an embodiment of the present invention can also be implemented with physical buttons. Furthermore, the graphic interface in the present invention is not limited by the embodiments of FIG. 5 to FIG. 9.

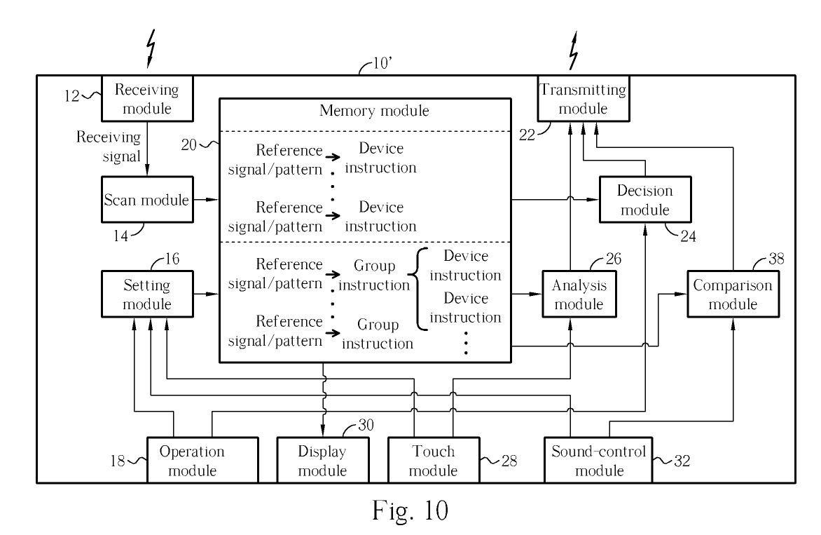

Please refer to FIG. 10, which is a block diagram of a remote controller 10′ of the present invention. Similar to the remote controller 10 in FIG. 1, the remote controller 10′ also comprises the receiving module 12, the scan module 14, the setting module 16, the operation module 18, the memory module 20, the transmitting module 22, the decision module 24, the analysis module 26, the touch module 28, and the display module 30. The remote controller 10′ further comprises a sound-control module 32 and a comparison module 38 related to sound-controlling so that a user can control the remote controller 10′ by voice. The sound-control module 32 comprises a microphone, which is utilized to receive or detect the voice of the user. The received (or detected) voice is then transformed into a corresponding electronic signal. When the remote controller 10′ operates under the scan mode or the setting mode, the user gives off a specific voice corresponding to a specific device instruction or a specific group instruction. The voice is then received by the sound-control module 32. The setting module 16 records the pattern of the voice as a reference pattern corresponding to the specific device or group instruction and stores the reference pattern in the memory module 20. When the remote controller 10′ operates under the remote-controlling mode, the user's voice can be received by the sound-control module 32. The comparison module 38 compares the voice with the reference patterns stored in the memory module 20. If the voice matches one of the reference patterns stored in the memory module 20, a corresponding device or group instruction is transmitted so that the aim of operating the remote controller 10′ of the present invention is reached.

In summary, compared with the prior art, the present invention enables a user to remotely control various remote controllers with a single remote controller and with various manipulations such as handwriting, pushing buttons, and voice. A plurality of device instructions can also be combined as a group instruction so that the combined device instruction can be transmitted sequentially. Therefore, the user is able to integrally remote-control various electronic devices with a single remote controller of the present invention in a convenient and intuitive manner. In the embodiments of FIG. 1 to FIG. 10, the modules can be implemented with hardware, software, and/or firmware. For example, in FIG. 10, the setting module 16, the analysis module 26, the comparison module 38, and the decision module 24 can be implemented with the same microprocessor running different software or firmware. Moreover, except for establishing the device instructions of the electronic devices in the scan mode or the scan procedure, other methods can also be utilized to establish the device instructions of the electronic devices. For example, built-in device instructions of various electronic devices are generated from the remote controller of the present invention. As long as the user chooses the type of electronic device, the remote controller of the present invention automatically establishes the device instructions corresponding to the electronic device so that the user can group the device instructions into group instructions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A remote controller for controlling multiple devices, comprising:
a memory module for storing a group instruction and a corresponding reference signal, the group instruction having a plurality of device instructions, and the device instructions capable of driving an electronic device to execute a plurality of functions;
a decision module for determining whether an operation signal matches the reference signal in the memory module; and
a transmitting module, wherein when the operation signal matches the reference signal, the transmitting module transmits the corresponding reference signal to make the device instructions of the group instruction drive the electronic device to execute sequentially the functions.

2. The remote controller of claim 1, further comprising a setting module, wherein when the remote controller operates in a setting mode, the setting module is capable of providing the corresponding reference signal and the group instruction according to the operation signal, and recording the corresponding reference signal and the group instruction into the memory module.

3. The remote controller of claim 2, wherein the setting module is capable of making the group instruction set up device instructions sequentially.

4. The remote controller of claim 1, wherein when the transmitting module transmits the group instruction of the corresponding reference signal, the device instructions of the group instruction drive the electronic device to execute the functions sequentially.

5. The remote controller of claim 2, further comprising:
a receiving module, wherein when the remote controller operates in a scan mode, the receiving module is capable of receiving a wireless signal of another remote controller; and
a scan module for providing the device instructions of the other remote controller, wherein when the remote controller operates in the setting mode, the setting module is capable of the device instructions of the other remote controller to the corresponding reference signal according to an operation of a user.

6. The remote controller of claim 1, further comprising:
a touch module for sensing a handwriting trace and providing a corresponding touch signal; and
an analysis module for determining whether the handwriting trace matches the corresponding reference signal of the memory module according to the touch signal, wherein when the analysis module detects a match, the transmitting module is capable of sending the group instruction of the corresponding reference signal to make the device instructions of the group instruction drive the electronic device to execute the functions.

7. The remote controller of claim 1, further comprising:
a sound-control module for sensing sound and providing a sound-control signal; and
a comparison module for determining whether the sound-control signal matches the reference signal recorded in the memory module, wherein when the comparison module detects a match, the transmitting module is capable of sending the group instruction of the corresponding reference signal to make the device instructions of the group instruction drive the electronic device to execute the functions.

8. A remote controller for controlling multiple devices comprising:
a touch module for detecting a handwriting trace;
a memory module for recording a group instruction and a corresponding reference signal, the group instruction having a plurality of device instructions, and the device instructions capable of driving an electronic device to execute a plurality of functions;
an analysis module for determining whether the handwriting trace matches the corresponding reference signal of the memory module; and
a transmitting module, wherein when the handwriting signal compared by the analysis module matches the corresponding reference signal, the transmitting module is capable of transmitting the group instruction of the corresponding reference signal for making the device instructions of the group instruction drive the electronic device to execute the functions.

9. The remote controller of claim 8, being capable of operating in a setting mode and a remote mode, wherein the remote controller further includes a setting module, wherein when the remote controller operates in the setting mode, the setting module is capable of providing the corresponding reference signal and the group instruction corresponding to the handwriting trace and recording the corresponding reference signal and the group instruction into the memory module.

10. The remote controller of claim 9, wherein the setting module is capable of making the group instruction set up device instructions sequentially.

11. The remote controller of claim 9, wherein when the transmitting module transmits the reference signal corresponding to the group instruction, the device instructions of the group instruction drive the electronic device to execute the functions.

12. The remote controller of claim 9, wherein when the remote controller operates in the remote mode, the analysis module is capable of determining whether the handwriting trace matches the corresponding reference signal in the memory module.

13. The remote controller of claim 9, being further capable of operating in a scan mode, the remote controller further comprising:
a receiving module, wherein when the remote controller operates in the scan mode, the receiving module is capable of receiving a wireless signal from another remote controller; and
a scan module for providing a corresponding device instruction of the other remote controller, wherein when the remote controller operates in the setting mode, the setting module is capable of corresponding the device instructions of the other remote controller to the corresponding reference signal according to an operation of a user.

14. The remote controller of claim 8, further comprising a display module capable of making the group instruction and device instructions display a corresponding graphic.

15. A method for a remote controller to control multiple devices, the method comprising:
determining whether a control signal matches a recorded reference signal, wherein the recorded reference signal corresponds to a group instruction; and
when the control signal matches the recorded reference sample, transmitting the group instruction, wherein the group instruction has a plurality of device instructions; and wherein the device instructions capable of driving an electronic device to execute a plurality of functions, and the device instructions of the group instruction are capable of driving the electronic device to execute the functions.

16. The method of claim 15, further comprising a setting procedure, the setting procedure comprising:
receiving an operation signal to produce a corresponding reference signal corresponding to the group instruction, and recording the corresponding reference signal for performing a setting procedure.

17. The method of claim 16, wherein the setting procedure further comprises:
making the group instruction sequentially set up a plurality of device instructions according to an operation of a user.

18. The method of claim 15, wherein when a transmitted reference signal matches the group instruction, the device instructions of the group instruction drive the electronic device to execute the functions.

19. The method of claim 16, further comprising a scan procedure, the scan procedure comprising:
receiving a wireless signal transmitted by another remote controller for providing the device instructions corresponding to the other remote controller to be used by the setting procedure.
